(19) United States
(12) Patent Application Publication
(10) Pub. No.: US 2012/0303265 A1
(43) Pub. Date: Nov. 29, 2012

(54) NAVIGATION SYSTEM WITH ASSISTANCE FOR MAKING MULTIPLE TURNS IN A SHORT DISTANCE

(75) Inventors: Chien-Wen Danny Su, Richmond Hill (CA); Mudassir Alam, Redmond, WA (US); Aarti Bharathan, Redmond, WA (US); Juan Pablo Candelas Gonzalez, Redmond, WA (US); Adrian Solis, Bellevue, WA (US); Jonathan Aroner, Seattle, WA (US); Eric Chih Hung Wang, Redmond, WA (US)

(73) Assignee: Microsoft Corporation, Redmond, WA (US)

(21) Appl. No.: 13/213,987

(22) Filed: Aug. 19, 2011

Related U.S. Application Data
(60) Provisional application No. 61/489,101, filed on May 23, 2011.

(51) Int. Cl. G01C 21/34

(52) U.S. Cl. 701/419; 701/428

(57) ABSTRACT

Techniques and tools are described for providing navigation assistance when there are multiple turns in succession in a short period of time or distance. In one embodiment, the route information can be reviewed to determine multiple turns in sequence that are less than a predetermined distance apart. These so-called “tight turns” can be handled differently than other turns by announcing the tight turns in a single combination instruction. Additional lane guidance can also be provided. In another embodiment, an audio feedback can be used to indicate that a user completed a successful turn. Such audio feedback can be in combination with the identified tight turns or independently for other turns or events. The audio feedback can also be an indication for the user to tap the display, wherein the tapping results in an immediate indication of the next turn.

### BACKGROUND

Computer-aided map navigation tools have achieved widespread acceptance. A user can find an address or directions with map navigation tools available at various Web sites. Some software programs allow a user to navigate over a map, zooming in towards the ground or zooming out away from the ground, or moving between different geographical positions. In cars, GPS devices have provided rudimentary road navigation for years. More recently, map navigation software for cellular telephones and other mobile computing devices has allowed users to zoom in, zoom out, and move around a map that shows details about geographical features, town, city, county and state locations, roads, and buildings.

Many navigation systems treat all turns the same, without thought to a situation where multiple turns can occur in succession in a short duration. For example, where a route has multiple turns in less than 0.3 miles, the user can often end up missing a turn because the next turn is only announced upon detection that the previous turn has been completed. By the time the next turn is announced, the user has little time to prepare for the turn or has already missed the turn.

### SUMMARY

Techniques and tools are described for providing navigation assistance when there are multiple turns in succession in a short period of time or a short distance.

In one embodiment, the route information can be reviewed to determine multiple turns in sequence that are less than a predetermined distance apart. In one example, the predetermined distance can be 0.5 of a mile, but other distances can be used. Such tight turns can be handled differently than other turns by announcing the tight turns in a single combination instruction. Additional lane guidance can also be provided. Thus, for three turns N, N+1, and N+2, the announcement can be as follows: Announce Turn (N), Announce Turn (N+1), Lane Guidance (N+2).

In another embodiment, an audio feedback can be used to indicate that a user completed a successful turn. Thus, when the user completes a turn, a beep can indicate that another step in the route has been completed. Such audio feedback can be in combination with the identified tight turns or independently for other turns or events. The audio feedback can also be an indication for the user to tap the display, wherein such a tapping results in an immediate indication of the next turn. Thus, if the user completed Turn N, an audio indication would be played. The user can then provide an input command requesting further information. For example, the user can then tap the touch screen of the client device, and the client device would play the following announcements: Announce Turn (N+1), Lane Guidance (N+2). Other commands can also be used, such as voice commands, etc.

This Summary is provided to introduce a selection of concepts in a simplified form that is further described below in the Detailed Description. This summary is not intended to identify key features or essential features of the claimed subject matter, nor is it intended to be used as an aid in determining the scope of the claimed subject matter. Additional features and advantages of the invention will be made apparent from the following detailed description of embodiments that proceeds with reference to the accompanying drawings.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating an example mobile computing device in conjunction with which techniques and tools described herein may be implemented.

FIG. 2 is a block diagram illustrating an example software architecture for a map navigation tool that renders map views and list views.

FIGS. 3a and 3b are diagrams illustrating features of a generalized map view and generalized list view rendered using a map navigation tool.

FIGS. 4a-4c are example screenshots illustrating user interface features of list views rendered using a map navigation tool.

FIGS. 5a and 5b are examples of tight turns.

FIG. 6 is a flowchart of a method for providing audio instructions for tight turns.

FIG. 7 is a detailed flowchart of a method for identifying tight turns.

FIG. 8 is a flowchart of a method for playing an audio cue in response to completing a turn or other event in a route.

FIG. 9 illustrates different embodiments when turns are announced.

### DETAILED DESCRIPTION

### Example Mobile Computing Device

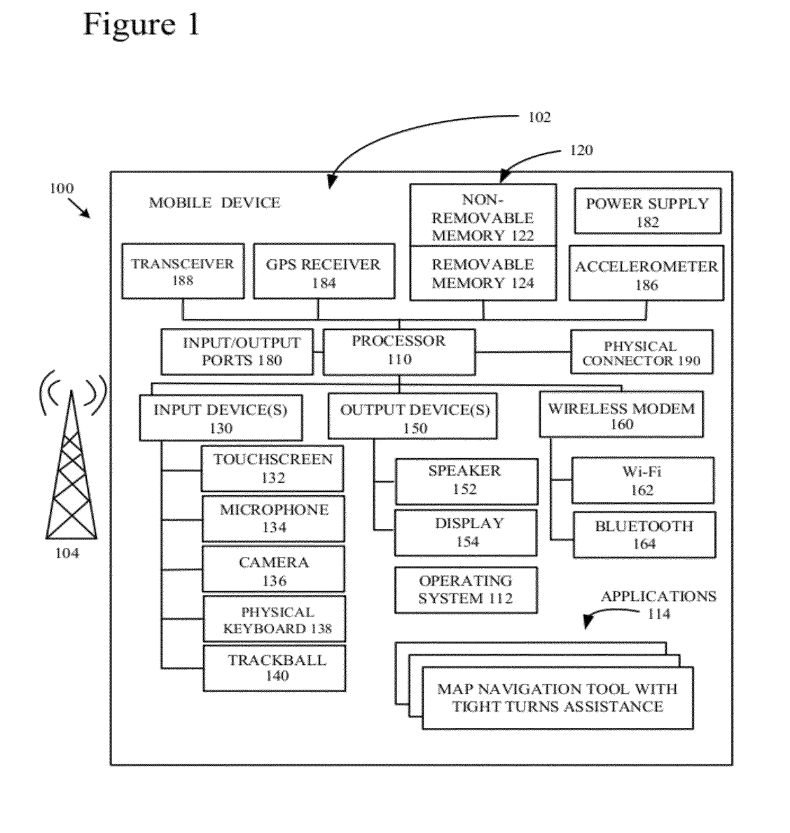

FIG. 1 depicts a detailed example of a mobile computing device (100) capable of implementing the techniques and solutions described herein. The mobile device (100) includes a variety of optional hardware and software components, shown generally at (102). In general, a component (102) in the mobile device can communicate with any other component of the device, although not all connections are shown, for ease of illustration. The mobile device can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks (104), such as a Wi-Fi, cellular, or satellite network.

The illustrated mobile device (100) includes a controller or processor (110) (e.g., signal processor, microprocessor, ASIC, or other control and processing logic circuitry) for performing such tasks as signal coding, data processing, input/output processing, power control, and/or other functions. An operating system (112) controls the allocation and usage of the components (102) and support for one or more application programs (114) such as a map navigation tool that implements one or more of the innovative features described herein. In addition to map navigation software, the application programs can include common mobile computing applications (e.g., telephony applications, email applications, calendars, contact managers, web browsers, messaging applications), or any other computing application.

The illustrated mobile device (100) includes memory (120). Memory (120) can include non-removable memory (122) and/or removable memory (124). The non-removable memory (122) can include RAM, ROM, flash memory, a hard disk, or other well-known memory storage technologies. The removable memory (124) can include flash memory or a Subscriber Identity Module (SIM) card, which is well known in Global System for Mobile Communications (GSM) communication systems, or other well-known memory storage technologies, such as “smart cards.” The memory (120) can be used for storing data and/or code for running the operating system (112) and the applications (114). Example data can include web pages, text, images, sound files, video data, or other data sets to be sent to and/or received from one or more network servers or other devices via one or more wired or wireless networks. The memory (120) can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device (100) can support one or more input devices (130), such as a touch screen (132) (e.g., capable of capturing finger tap inputs, finger gesture inputs, or keystroke inputs for a virtual keyboard or keypad), microphone (134) (e.g., capable of capturing voice input), camera (136) (e.g., capable of capturing still pictures and/or video images), physical keyboard (138), buttons and/or trackball (140) and one or more output devices (150), such as a speaker (152) and a display (154). Other possible output devices (not shown) can include piezoelectric or other haptic output devices. Some devices can serve more than one input/output function. For example, touchscreen (132) and display (154) can be combined in a single input/output device.

The computing device 100 can provide one or more natural user interfaces (NUIs). For example, the operating system 112 or applications 114 can comprise speech-recognition software as part of a voice user interface that allows a user to operate the device 100 via voice commands. For example, a user's voice commands can be used to provide input to a map navigation tool.

A wireless modem (160) can be coupled to one or more antennas (not shown) and can support two-way communications between the processor (110) and external devices, as is well understood in the art. The modem (160) is shown generically and can include, for example, a cellular modem for communicating at long range with the mobile communication network (104), a Bluetooth-compatible modem (164), or a Wi-Fi-compatible modem (162) for communicating at short range with an external Bluetooth-equipped device or a local wireless data network or router. The wireless modem (160) is typically configured for communication with one or more cellular networks, such as a GSM network for data and voice communications within a single cellular network, between cellular networks, or between the mobile device and a public switched telephone network (PSTN).

The mobile device can further include at least one input/output port (180), a power supply (182), a satellite navigation system receiver (184), such as a Global Positioning System (GPS) receiver, sensors (186) such as an accelerometer, a gyroscope, or an infrared proximity sensor for detecting the orientation and motion of device 100, and for receiving gesture commands as input, a transceiver (188) (for wirelessly transmitting analog or digital signals) and/or a physical connector (190), which can be a USB port, IEEE 1394 (FireWire) port, and/or RS-232 port. The illustrated components (102) are not required or all-inclusive, as any of the components shown can be deleted and other components can be added.

The mobile device can determine location data that indicates the location of the mobile device based upon information received through the satellite navigation system receiver (184) (e.g., GPS receiver). Alternatively, the mobile device can determine location data that indicates location of the mobile device in another way. For example, the location of the mobile device can be determined by triangulation between cell towers 104 of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to map navigation tool for use in map navigation. For example, the map navigation tool periodically requests, or polls for, current location data through an interface exposed by the operating system (112) (which in turn may get updated location data from another component of the mobile device), or the operating system (112) pushes updated location data through a callback mechanism to any application (such as the map navigation tool) that has registered for such updates.

With the map navigation tool and/or other software or hardware components, the mobile device (100) implements the technologies described herein. For example, the processor (110) can update a map view and/or list view in reaction to user input and/or changes to the current location of the mobile device. As a client computing device, the mobile device (100) can send requests to a server computing device, and receive map images, distances, directions, other map data, search results or other data in return from the server computing device.

The mobile device (100) can be part of an implementation environment in which various types of services (e.g., computing services) are provided by a computing “cloud.” For example, the cloud can comprise a collection of computing devices, which may be located centrally or distributed, that provide cloud-based services to various types of users and devices connected via a network such as the Internet. Some tasks (e.g., processing user input and presenting a user interface) can be performed on local computing devices (e.g., connected devices) while other tasks (e.g., storage of data to be used in subsequent processing) can be performed in the cloud.

Although FIG. 1 illustrates a mobile device (100), more generally, the techniques and solutions described herein can be implemented with devices having other screen capabilities and device form factors, such as a desktop computer, a television screen, or device connected to a television (e.g., a set-top box or gaming console). Services can be provided by the cloud through service providers or through other providers of online services. Thus, the map navigation techniques and solutions described herein can be implemented with any of the connected devices as a client computing device. Similarly, any of various computing devices in the cloud or a service provider can perform the role of server computing device and deliver map data or other data to the connected devices.

### Example Software Architecture for Rendering of Map Data and Directions

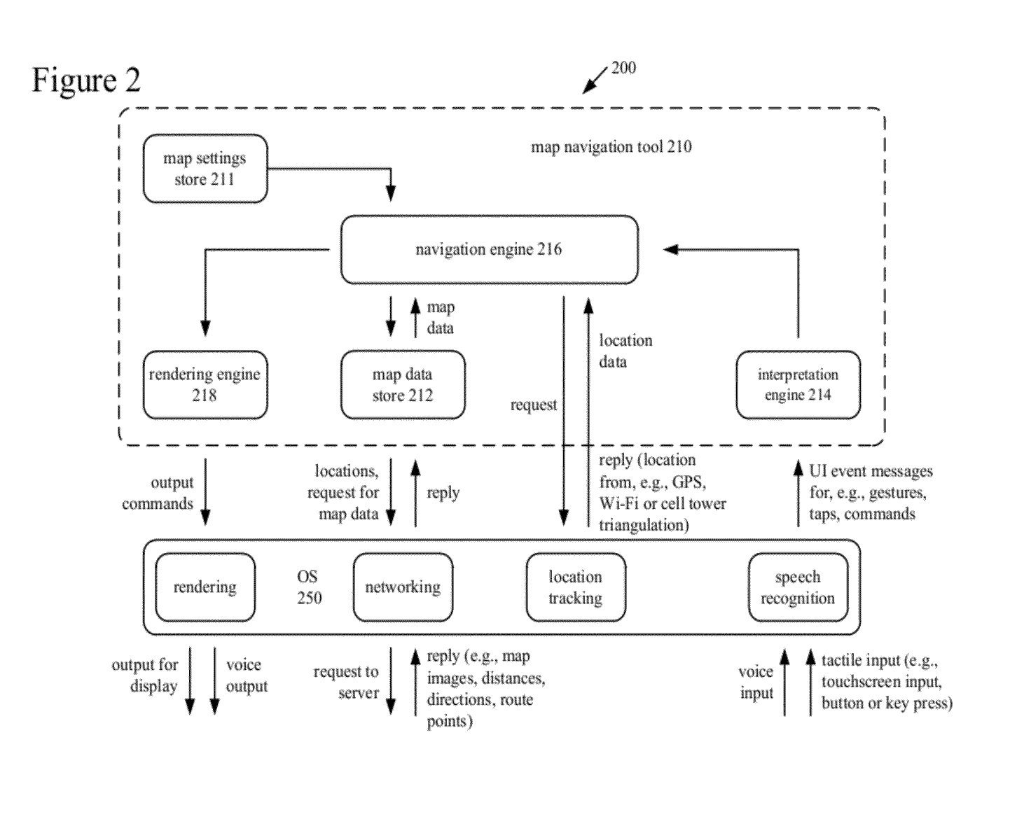

FIG. 2 shows an example software architecture (200) for a map navigation tool (210) that renders views of a map depending on user input and location data. A client computing device (e.g., smart phone or other mobile computing device) can execute software organized according to the architecture (200) to render map views, list views of directions for a route, or other views.

The architecture (200) includes a device operating system (OS) (250) and map navigation tool (210). In FIG. 2, the device OS (250) includes components for rendering (e.g., rendering visual output to a display, generating voice output for a speaker), components for networking, components for location tracking, and components for speech recognition. The device OS (250) manages user input functions, output functions, storage access functions, network communication functions, and other functions for the device. The device OS (250) provides access to such functions to the map navigation tool (210).

A user can generate user input that affects map navigation. The user input can be tactile input such as touchscreen input, button presses or key presses or voice input. The device OS (250) includes functionality for recognizing taps, finger gestures, etc. to a touchscreen from tactile input, recognizing commands from voice input, button input or key press input, and creating messages that can be used by map navigation tool (210) or other software. The interpretation engine (214) of the map navigation tool (210) listens for user input event messages from the device OS (250). The UI event messages can indicate a panning gesture, flicking gesture, dragging gesture, or other gesture on a touchscreen of the device, a tap on the touchscreen, keystroke input, or other UI event (e.g., from voice input, directional buttons, trackball input). If appropriate, the interpretation engine (214) can translate the UI event messages from the OS (250) into map navigation messages sent to a navigation engine (216) of the map navigation tool (210).

The navigation engine (216) considers a current view position (possibly provided as a saved or last view position from the map settings store (211)), any messages from the interpretation engine (214) that indicate a desired change in view position, map data and location data. From this information, the navigation engine (216) determines a view position and provides the view position as well as location data and map data in the vicinity of the view position to the rendering engine (218). The location data can indicate a current location (of the computing device with the map navigation tool (210)) that aligns with the view position, or the view position can be offset from the current location.

The navigation engine (216) gets current location data for the computing device from the operating system (250), which gets the current location data from a local component of the computing device. For example, the location data can be determined based upon data from a global positioning system (CiPS), by triangulation between towers of a cellular network, by reference to physical locations of Wi-Fi routers in the vicinity, or by another mechanism.

The navigation engine (216) gets map data for a map from a map data store (212). In general, the map data can be photographic image data or graphical data (for boundaries, roads, etc.) at various levels of detail, ranging from high-level depiction of states and cites, to medium-level depiction of neighborhoods and highways, to low-level depiction of streets and buildings. Aside from photographic data and graphical data, the map data can include graphical indicators such as icons or text labels for place names of states, cities, neighborhoods, streets, buildings, landmarks or other features in the map. Aside from names, the map data can include distances between features, route points (in terms of latitude and longitude) that define a route between start and end locations, text directions for decisions at waypoints along the route (e.g., turn at NE 148^{th}), and distances between waypoints along the route. The map data can provide additional details for a given feature such as contact information (e.g., phone number, Web page, address), reviews, ratings, other commentary, menus, photos, advertising promotions, or information for games (e.g., geo-caching, geo-tagging). Links can be provided for Web pages, to launch a Web browser and navigate to information about the feature.

The organization of the map data depends on implementation. For example, in some implementations, different types of map data (photographic image data or graphical surface layer data, text labels, icons, etc.) are combined into a single layer of map data at a given level of detail. Up to a certain point, if the user zooms in (or zooms out), a tile of the map data at the given level of detail is simply stretched (or shrunk). If the user more further zooms in (or zooms out), the tile of map data at the given level of detail is replaced within one or more other tiles at a higher (or lower) level of detail. In other implementations, different types of map data are organized in different overlays that are composited during rendering, but zooming in and out are generally handled in the same way, with overlapping layers stretched (or shrunk) up to a point, then replaced with tiles at other layers.

The map data store (212) caches recently used map data. As needed, the map data store (212) gets additional or updated map data from local file storage or from network resources. The device OS (250) mediates access to the storage and network resources. The map data store (212) requests map data from storage or a network resource through the device OS (250), which processes the request, as necessary requests map data from a server and receives a reply, and provides the requested map data to the map data store (212).

For example, to determine directions for a route, the map navigation tool (210) provides a start location (typically, the current location of the computing device with the map navigation tool (210)) and an end location for a destination (e.g., an address or other specific location) as part of a request for map data to the OS (250). The device OS (250) conveys the request to one or more servers, which provide surface layer data, route points that define a route, text directions for decisions at waypoints along the route, distances between waypoints along the route, and/or other map data in reply. The device OS (250) in turn conveys the map data to the map navigation tool (210).

As another example, as a user travels along a route, the map navigation tool (210) gets additional map data from the map data store (212) for rendering. The map data store (212) may cache detailed map data for the vicinity of the current location, using such cached data to incrementally change the rendered views. The map navigation tool (210) can pre-fetch map data along the route, or part of the route. Thus, as the rendered map views are updated to account for changes to the current location, the map navigation tool (210) often updates the display without the delay of requesting/receiving new map data from a server. As needed, the map data store (212) requests additional map data to render views.

The rendering engine (218) processes the view position, location data and map data, and renders a view of the map. Depending on the use scenario, the rendering engine (218) can render map data from local storage, map data from a network server, or a combination of map data from local storage and map data from a network server. In general, the rendering engine (218) provides output commands for the rendered view to the device OS (250) for output on a display. The rendering engine (218) can also provide output commands to the device OS (250) for voice output over a speaker or headphones.

The exact operations performed as part of the rendering depend on implementation. In some implementations, for map rendering, the tool determines a field of view and identifies features of the map that are in the field of view. Then, for those features, the tool selects map data elements. This may include any and all of the map data elements for the identified features that are potentially visible in the field of view. Or, it may include a subset of those potentially visible map data elements which are relevant to the navigation scenario (e.g., directions, traffic). For a given route, the rendering engine (218) graphically connects route points along the route (e.g., with a highlighted color) to show the route and graphically indicates waypoints along the route. The tool composites the selected map data elements that are visible (e.g., not obscured by another feature or label) from the view position. Alternatively, the tool implements the rendering using acts in a different order, using additional acts, or using different acts.

In terms of overall behavior, the map navigation tool can react to changes in the location of the computing device and can also react to user input that indicates a change in view position, a change in the top item in a list of directions for a route, or other change. For example, in response to a finger gesture or button input that indicates a panning instruction on the map, or upon a change to a previous item or next item in a list of directions for a route, the map navigation tool can update the map with a simple, smooth animation that translates (shifts vertically and/or horizontally) the map. Similarly, as the location of the computing device changes, the map navigation tool can automatically update the map with a simple translation animation. (Or, the map navigation tool can automatically re-position and re-render an icon that indicates the location of the computing device as the location is updated.) If the change in location or view position is too large to be rendered effectively using a simple, smooth translation animation, the map navigation tool can dynamically zoom out from at first geographic position, shift vertically and/or horizontally to a second geographic position, then zoom in at the second geographic position. Such a dynamic zoom operation can happen, for example, when a phone is powered off then powered on at a new location, when the view position is re-centered to the current location of the device from far away, when the user quickly scrolls through items in a list of directions for a route, or when the user scrolls to a previous item or next item in the list of directions that is associated with a waypoint far from the current view position. The map navigation tool can also react to a change in the type of view (e.g., to switch from a map view to a list view, or vice versa), a change in details to be rendered (e.g., to show or hide traffic details).

Alternatively, the map navigation tool (210) includes more or fewer modules. A given module can be split into multiple modules, or different modules can be combined into a single layer. For example, the navigation engine can be split into multiple modules that control different aspects of navigation, or the navigation engine can be combined with the interpretation engine and/or the rendering engine. Functionality described with reference to one module (e.g., rendering functionality) can in some cases be implemented as part of another module.

### Example Map Navigation UI and Screenshots

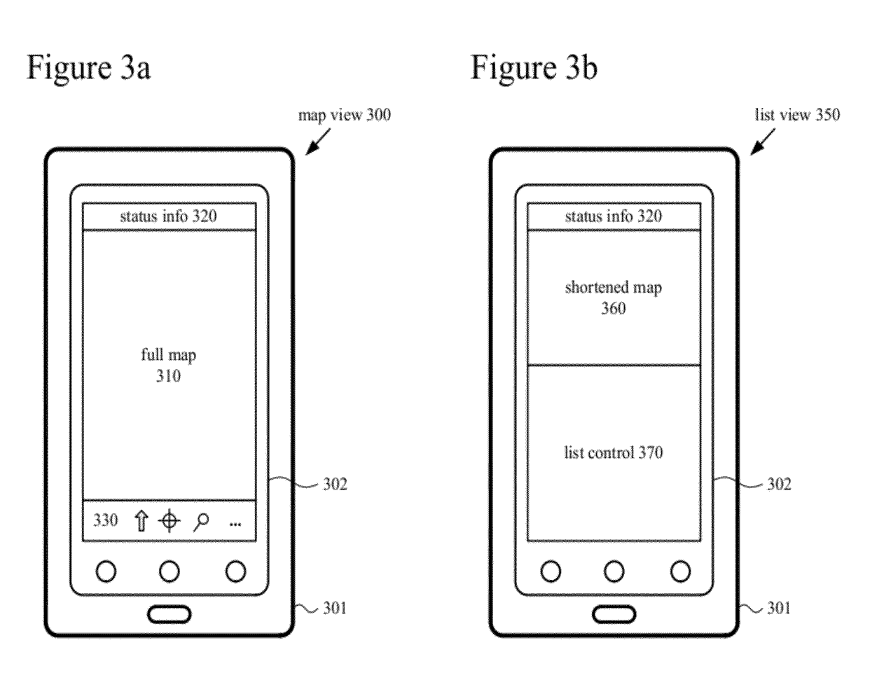

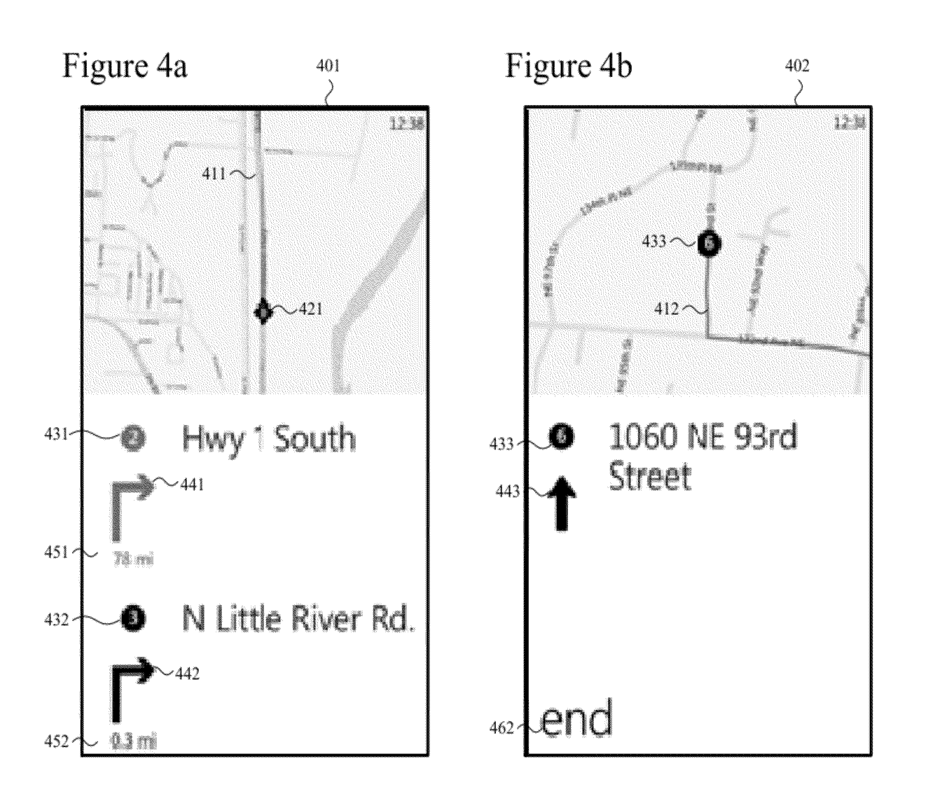

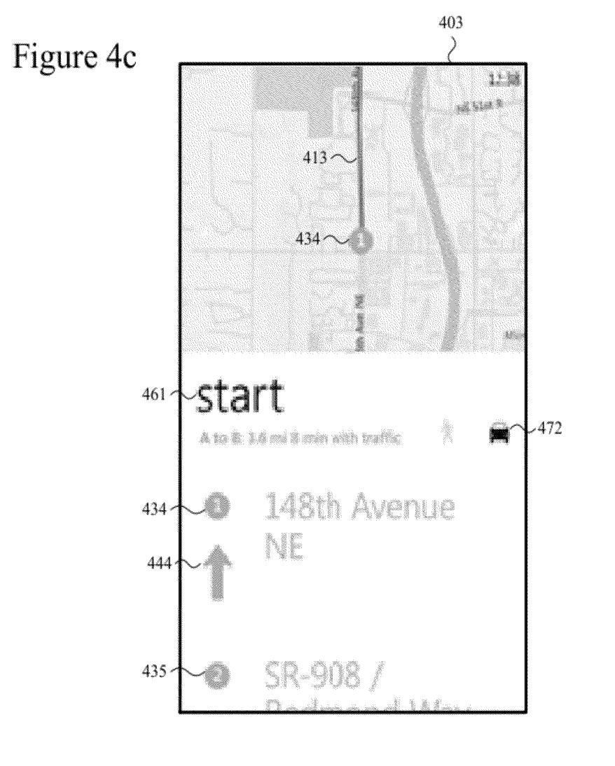

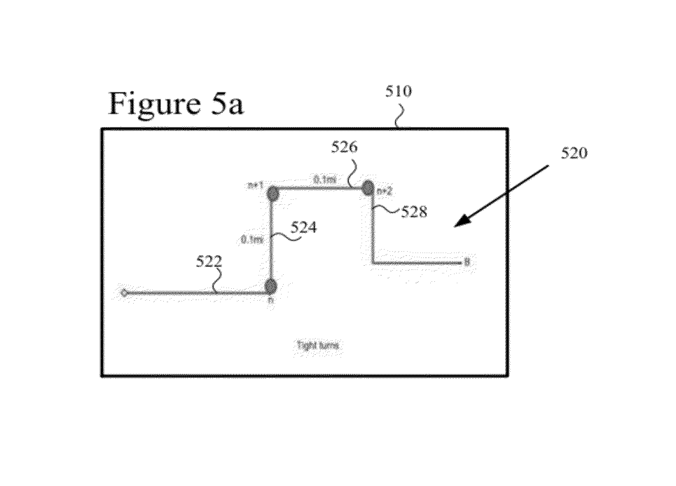

FIGS. 3a and 3b illustrate a generalized map view (300) and generalized direction list view (350), respectively, rendered using a map navigation tool of a mobile computing device (301). FIGS. 4a-4c show example screenshots (401, 402, 403) of a list view of a map navigation UI.

The device (301) includes one or more device buttons. FIGS. 3a and 3b show a single device button near the bottom of the device (301). The effect of actuating the device button depends on context. For example, actuation of the device button causes the device (301) to return to a home screen or start screen from the map navigation tool. Alternatively, the device (301) includes no device buttons.

The device (301) of FIGS. 3a and 3b includes a touchscreen (302) with a display area and three touchscreen buttons. The effect of actuating one of the touchscreen buttons depends on context and which button is actuated. For example, one of the touchscreen buttons is a search button, and actuation of the search button causes the device (301) to start a Web browser at a search page, start a search menu for contacts or start another search menu, depending on the point at which the search button is actuated. Or, one of the touchscreen buttons is a “back” button that can be used to navigate the user interface of the device. Alternatively, the device includes more touchscreen buttons, fewer touchscreen buttons or no touchscreen buttons. The functionality implemented with a physical device button can be implemented instead with a touchscreen button, or vice versa.

In the display area of the touchscreen (302), the device (301) renders views. In FIG. 3a, as part of the map view (300), the device (301) renders a full map (310) and status information (320) that overlays the top of the full map (310). The status information (320) can include time, date, network connection status and/or other information. The device (301) also renders a control section (330) that includes map navigation buttons, which depend on implementation of the map navigation tool. FIG. 3a shows a “directions” button (arrow icon), “re-center” button (crosshairs icon) and “search” button (magnifying glass icon). Actuation of the “directions” button causes the device (301) to open menu for keystroke input for a destination location. Actuation of the “center” button causes the device (301) to align the view position over the current location of the device (301). Actuation of the “search” button causes the device (301) to open menu for keystroke input for a search for a location or locations. Other buttons/controls can be accessed by actuating the ellipses, such as buttons/controls to clear the map of extra data, show/hide photographic image details, show/hide traffic data, show/hide route directions, change settings of the map navigation tool such as whether voice instructions are input or whether orientation of the view changes during progress along the route, etc. Alternatively, the device includes more map navigation buttons, fewer map navigation buttons or no map navigation buttons.

In FIG. 3b, as part of the list view (350), the device (301) renders a shortened map (360), status information (320) that overlays the top of the shortened map (360), and a list control (370). The shortened map (360) shows map details as in the full map (310) but also shows graphical details of at least part of a route between a start location and end location. The list control (370) shows text details and icons for directions along the route. FIGS. 4a-4c show example screenshots (401, 402, 403) of list views, each including a shortened map (360) and list control (370) as well as status information (320) (namely, time) that overlays the shortened map (360).

The screenshots (401, 402, 403) in FIGS. 4a-4c show different list views for a route between a start location and end location. In the screenshot (401) of FIG. 4a, a graphical icon (421) shows the current location along the route in the map portion of the list view. Part of the route (411) is shown in a highlighted color relative to the rest of the map data. The list control of the screenshot (401) includes waypoint icons (431, 432) and text details for waypoints along the route. Items in the list of direction are organized as waypoints, which represent points at which the user is given specific directions to turn, continue straight, take an exit, etc. Below the waypoint icons (431, 432), direction icons (441, 442) graphically represent the active part of the directions, e.g., to turn continue straight, take and exit associated with the respective waypoints. Distance values (451, 452) indicate the distance between waypoints (as in the distance (452) between waypoints 2 and 3) or distance between the current location and the upcoming waypoint (as in the distance (451) to waypoint 2).

The color of the waypoint icons (441, 442), text details, direction icons (441, 442) and distance values (451, 452) can change depending on the status of progress along the route. In FIG. 4a, the waypoint icon (431), text and direction icon (441) for waypoint 2 are rendered in an accent color to indicate waypoint 2 is the upcoming item in the list of directions. On the other hand, the waypoint icon (432), associated text and direction icon (442) for waypoint 3 are rendered in a neutral color to indicate waypoint 3 is further in the future.

The screenshot (402) of FIG. 4b shows the list view after the user scrolls to the end of the list of directions, which is graphically represented with text (462). Waypoint icons (433) represent a final waypoint in the map portion and list control of the list view. The map portion highlights part (412) of the route graphically. In the list control, the waypoint icon (433) is followed by text associated with the waypoint and a direction icon (443), but not a distance value since the waypoint is the final waypoint. The waypoint icon (433), associated text and direction icon (443) for the final, future waypoint are rendered in a neutral color.

The screenshot (403) of FIG. 4c shows the list view after the user scrolls back to the start of the list of directions, which is graphically represented with text (461). The map portion shows part (413) of the route graphically, but the completed part of the route is grayed out.

Waypoint icons (434) represent an initial waypoint in the map portion and list control of the list view, and are also grayed out to show that the initial waypoint has been passed. Another waypoint icon (435) represents a subsequent waypoint. In the list control, space permitting, the waypoint icons (434, 435) are followed by text associated with the waypoints and direction icons (444), also grayed out, but not distance value since the waypoints have been passed. The list control also includes transit mode icons (472) that the user can actuate to switch between modes of transit (e.g., walking, car, bus).

### Example Map Showing Tight Turns

Tight turns are those turns that occur sequentially in less than a predetermined total distance. For example, if two or more turns occur within a distance of less than 0.3 miles, then the turns are treated as a special case wherein a combination instruction is created to announce the turns together as a single instruction. Other predetermined distances can be used, such as distances between 0.1-0.5 miles.

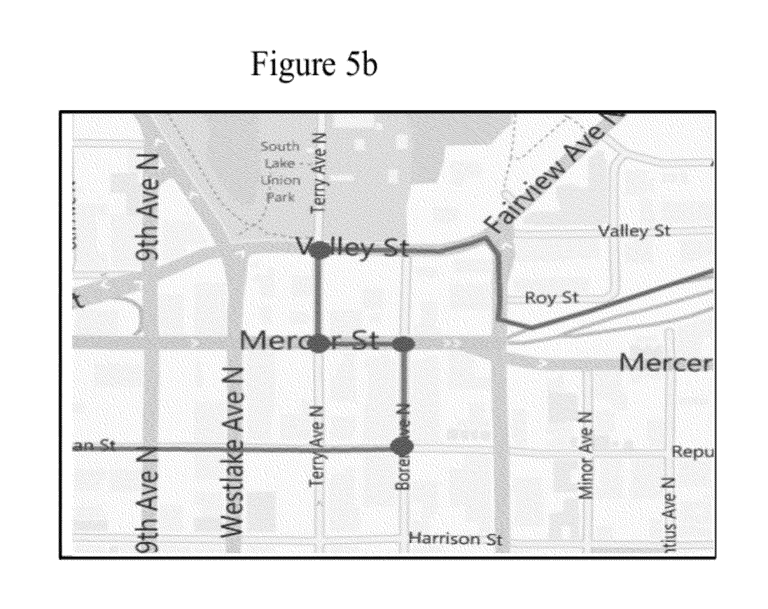

FIG. 5a shows an example where tight turns occurs. The map 510 shows a route 520 with multiple legs 522, 524, 526 and 528. Each leg has a distance associated with it. For example, both legs 524 and 526 are shown as having a distance of 0.1 miles. Nodes n, n+1, n+2 are shown between the legs representing turns that are made during the route. When two or more turns occur within a short distance or duration then the turns are considered tight turns. In this example, turns n, n+1 and n+2 occur within 0.2 miles, which can be less than a predetermined setting of 0.3 miles, for example. As described further below, when multiple turns occur in succession in less than a predetermined distance or duration, then an oral announcement is made treating the multiple turns as a single instruction. Lane guidance can also be provided. For example, just prior to turn n, the system can perform the following: Announce (n), Announce (n+1), and Lane Guidance (n+2). As a further feature, after turn n is completed, an audio cue can be made to indicate that the turn was completed. In response to the audio cue, the user can provide a request or command to hear an updated announcement. For example, the user can tap the touch screen to hear an updated announcement, or the user can provide a voice command, etc. Any form of user request can be used. In response to the request, the system can, for example, perform the following: Announce (n+1), Lane Guidance (n+2). An additional feature can be that the turns remain separately listed in the list control. Thus, in the written portion, the turns remain as independent instructions, despite that they are announced in a combination instruction. Thus, multiple tight turns can be announced together with lane guidance prior to making the first of the tight turns. Having such information in advance assists the user to navigate through a difficult portion in the route.

FIG. 5b shows another example with two turns shown within a short distance. Similar tight-turns announcements can occur for two turns, wherein lane guidance can also be provided after the second turn.

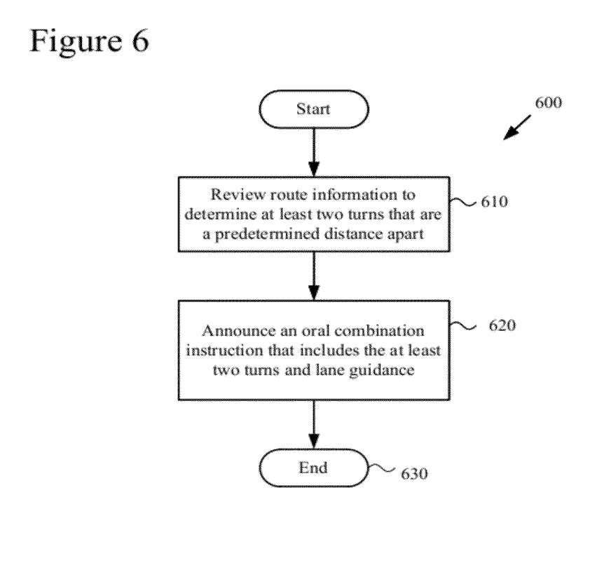

FIG. 6 is a flowchart of a method 600 for implementing a combination instruction for tight turns. In process block 610, the system reviews route information to determine at least two turns that are a predetermined distance apart. The system can be programmed to determine at least three turns or at least four turns that are closely spaced. Additionally, a user can adjust the settings for the definition of tight turns. In any event, in process block 610, the tight turns along the route are determined sometime prior to the turns being encountered. Indeed, the tight turns can be identified immediately after the route information is received from the server computer. The tight turns can also be based on other information, like a particular road segment's speed limit or the user's current speed as he or she approaches the turns. In process block 620, prior to arriving at the series of tight turns an oral combination instruction is announced that includes at least two turns and lane guidance. Alternatively, three turns can be announced as a single combination instruction: Announce (n), Announce (n+1), Announce (n+2).

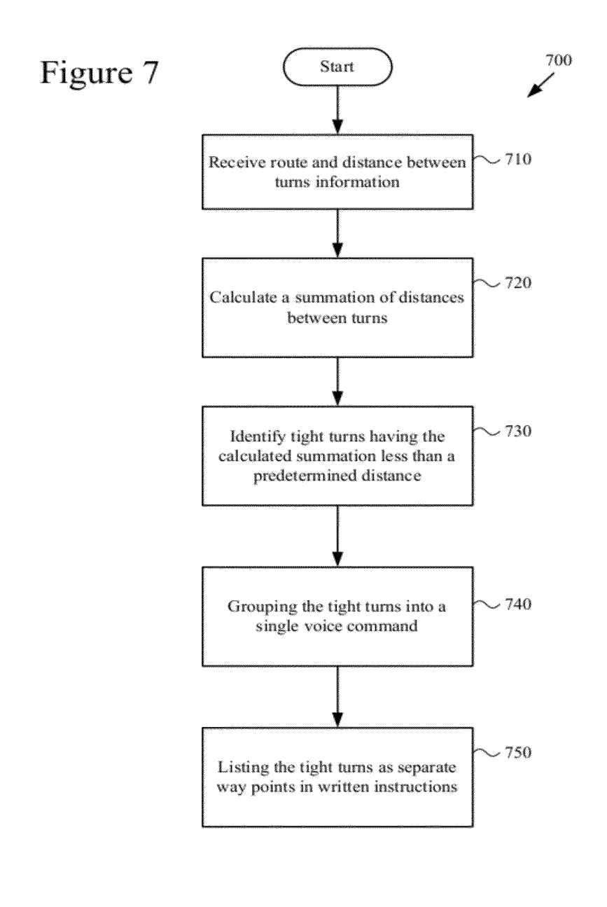

FIG. 7 shows a flowchart of a method 700 that provides additional implementation details that can be used. In process block 710, route and distance information is received from a server computer. Thus, a user first enters in destination information into a map application. The user's location (obtained from a GPS, for example) and destination are sent to a server computer. In response, the server determines the route and sends the route and distance between turns information to the client device. In process block 720, the map application on the client device checks each turn in the route and calculates a summation of distances between turns. In process block 730, tight turns are identified as turns having the calculated summation less than a predetermined distance. The predetermined distance can be any desired amount, such as 0.3, 0.4, or 0.5 miles. In process block 740, the tight turns are grouped in a single voice command. Thus, tight turns are treated differently than other turns. Prior to reaching the series of tight turns, the turns are announced in series before reaching the first turn. Thus, an example announcement can be as follows: “turn right on 3^{rd} Ave then left on Country Commons and then stay in the left lane.” In process block 750, the tight turns can be listed as separate way points in the written instructions. Thus, oral instructions for tight turns are treated differently, but written instruction can be treated the same as other turns.

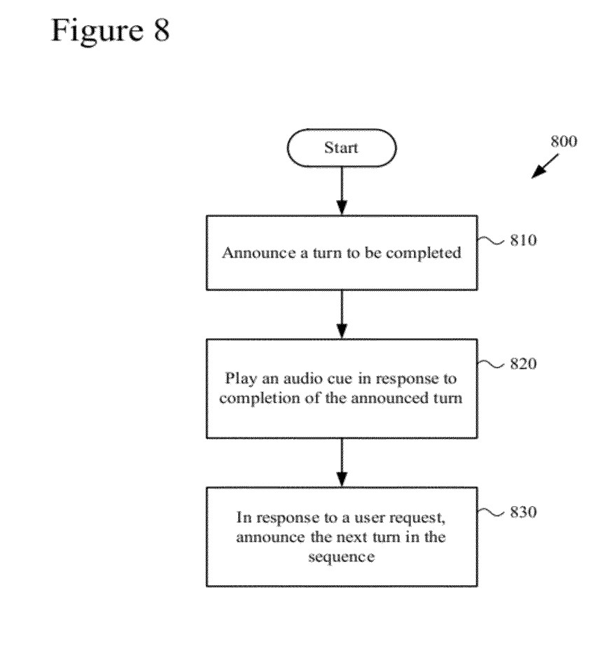

FIG. 8 shows a flowchart of a method 800 for providing an audio cue. In process block 810, a turn is announced. After the turn is completed, in process block 820, an audio cue is played in response to completion of the announced turn. This signals the user that a user input command (such as touching the screen) can invoke the audio announcement of the next turn in the route. The audio cue is particularly helpful when the user is in a series of tight turns.

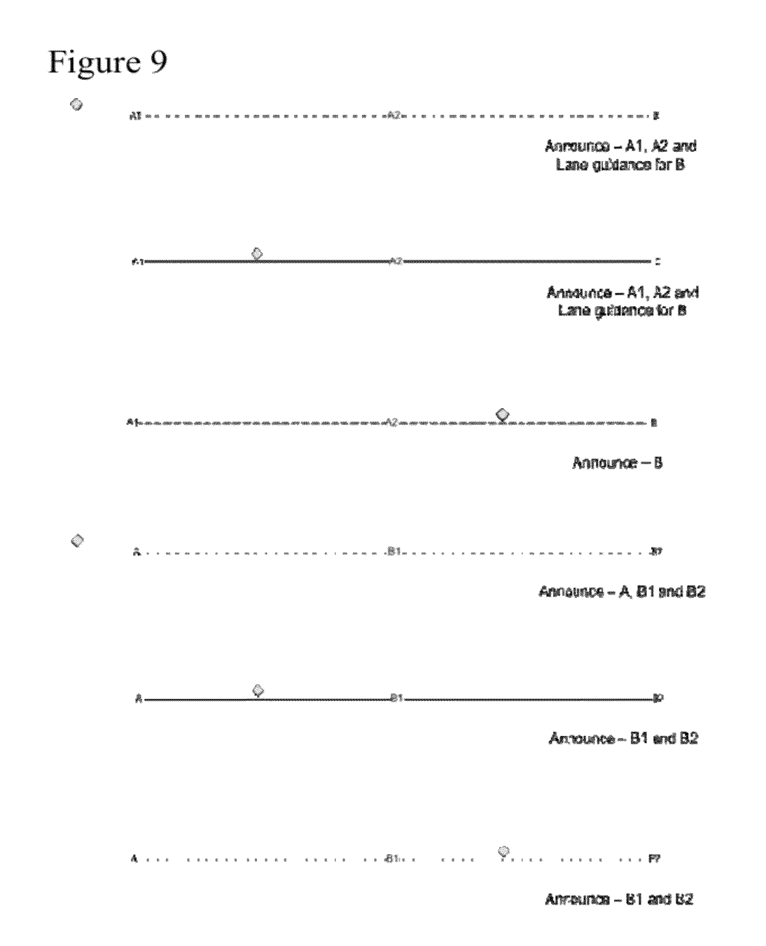

FIG. 9 shows different embodiments and different announcing scenarios that can be used with tight turns. The turns can be announced in any desired manner and combination.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of providing routing instructions in a navigation system, comprising:
reviewing route information to a desired destination to determine at least two turns in sequence that are less than a predetermined distance apart; and
for the identified turns and, at an appropriate time in the route, announcing an oral combination instruction that includes the at least two turns and lane guidance.

2. The method of claim 1, further including listing each turn in the route as a separate written instruction, including the individual identified turns in the combination instruction.

3. The method of claim 1, further including playing an audio indication when a turn has been completed.

4. The method of claim 3, further including receiving a user command for additional information and providing an audio instruction of a next turn in the route.

5. The method of claim 1, wherein the oral combination instruction includes at least three turns.

6. The method of claim 1, wherein the predetermined distance apart is 0.5 miles or less.

7. The method of claim 1, wherein the combination instruction announces the at least two turns prior to any of the turns.

8. The method of claim 1, further including obtaining current position information for an identified turn as a written instruction, wherein the identified turns that are included in the combination instruction are separately listed as independent turns.

9. The method of claim 1, further including receiving the route information and distance between turns from a server computer.

10. The method of claim 1, wherein the navigation system is implemented in an application running on a mobile device.

11. A method of providing route instructions in a navigation system on a mobile phone, comprising:
receiving route and distance-between-turns data from a server computer;
calculating a summation of distances between turns;
identifying tight turns having the calculated summation less than a predetermined distance;
grouping the tight turns into a single voice command so that multiple turns are announced prior to reaching the group tight turns; and
listing each of the tight turns as a separate way point in written instructions on the user interface of the mobile phone.

12. The method of claim 11, further providing an audio indication when a turn has been completed.

13. The method of claim 12, further including receiving an indication of a user input command for additional information, and playing an audio instruction of a next turn in the route in response to the user input command.

14. The method of claim 11, wherein the tight turns include three or more turns.

15. The method of claim 11, wherein the predetermined distance apart is 0.5 miles or less.

16. The method of claim 11, wherein the single voice command further includes lane guidance

17. A system for providing route instructions in a navigation system on a mobile phone, comprising:
a map application;
a positioning locator to locate a current position of the mobile phone, the positioning locator using one or more of the following for determining the current position: satellite information, cell tower information, or wireless transmitter information;
an operating system between the map application and the positioning locator for passing positioning information there between;
wherein the map application receives route information including distances between turns and calculates tight turns that include two or more turns so that the tight turns can be announced as a single instruction together with lane guidance information.

18. The system of claim 17, further including a user interface of the mobile phone for displaying way points, wherein the way points for the tight turns are separately listed.

19. The system of claim 17, further including a speech component for playing an audio cue in response to a turn being completed.

20. The system of claim 19, wherein the map application is responsive to receiving user input after the audio cue for playing the next turn information using the speech component.
